(19) United States
(12) Patent Application Publication
(10) Pub. No.: US 2005/0175336 A1
(43) Pub. Date: Aug. 11, 2005

(54) Maintenance cartridge or device for a film developing system field of the invention

(76) Inventors: Kosta S. Selinidis, Austin, TX (US); Paul N. Winberg, Austin, TX (US); Joseph B. Gault, Portland, OR (US)

Correspondence Address: Mark G. Bocchetti;Patent Legal Staff, Eastman Kodak Company, 343 State Street, Rochester, NY, 14650-2201, US

(21) Appl. No.: 10/776,747

(22) Filed: Feb. 11, 2004

(51) Int. Cl. G03D 13/00

(52) U.S. Cl. 396/564

(57) ABSTRACT

A digital film processing system and film processing solution or development cartridge are disclosed. The cartridge comprises a housing and a chamber for storing a film processing fluid. The cartridge may also include an applicator nozzle for coating the processing solution onto undeveloped film. The system includes a cleaning and capping device or arrangement that is adapted to clean and seal an opening of the applicator nozzle.

### FIELD OF THE INVENTION

The present invention relates generally to film developing systems that include a film processing solution or development cartridge having a solution applicator nozzle, and more particularly, a system or maintenance cartridge or device that is adapted to clean and seal an opening of the applicator nozzle.

### BACKGROUND OF THE INVENTION

Images are used to communicate information and ideas. Images, including print pictures, film negatives, documents and the like, are often digitized to produce a digital image that can then be instantly communicated, viewed, enhanced, modified, printed or stored. The flexibility of digital images, as well as the ability to instantly communicate digital images, has led to a rising demand for improved systems and methods for film processing and the digitization of film based images into digital images. Film based images are traditionally digitized by electronically scanning a film negative or film positive that has been conventionally developed using a wet chemical developing process where the film is immersed in different processing solutions.

In a process and system in accordance with the present invention, the film is scanned during the development process. This system and process can be defined as a DFP (Digital Film Processing) system (see, for example, U.S. Pat. No. 6,599,036). In DFP systems, a thin coat of one or more film processing solutions is applied to the film and then the film is scanned through the coating. Neither the processing solutions nor the silver compounds within the film are washed from the film. DFP systems may comprise a number of different configurations depending upon the method of film processing and the method of scanning the film. For example, in some embodiments, the metallic silver grains and silver halide are not modified and the film is scanned with visible light.

In DFP systems, a developer cartridge holds the processing solution or fluid therein and is adapted to apply or coat the solution or fluid onto the film through a coating system such as an applicator nozzle. In such an arrangement, it is possible that the coating system will be intermittently used which can lead to a drying out of the solution or fluid inside the nozzle opening or on the surrounding surfaces of the opening. This can result in a build-up of fluid residue around the tip of the nozzle and clogged nozzles that can produce uneven coatings and lead to image defects.

### SUMMARY OF THE INVENTION

The present invention provides for a system and process for cleaning an applicator nozzle of a developer cartridge at the completion of a coating cycle, and sealing the applicator nozzle when not in use so as to prevent a drying out of the solution or fluid inside the nozzle opening or on the surrounding surfaces of the opening.

The system and process of the present invention permit extended periods of non-use of the coating system between coating cycles. This is beneficial in an “on-demand” coating system that will be used at random times as dictated by the use profile of a particular installation. For example, a coating system may be required to produce coatings in a repeating coating cycle for a period of 30 minutes or more, than become inactive for periods of 24 hours or more. Each time the coating system is required to start a coating cycle after some extended period of inactivity, it must be able to produce a coating of known thickness and width.

Therefore, with the system and method of the present invention it is possible to increase the storage life of the solution or fluid in the cartridge, minimize fluid consumption, provide even fluid coatings, eliminate image defects due to coating variations and eliminate debris issues from coating residue near the nozzle opening.

The present invention therefore relates to a maintenance method for an applicator nozzle of a development cartridge adapted to apply processing fluid onto photographic media. The method comprises the steps of: moving a face of an applicator nozzle of a development cartridge into contact with a web of a cleaning device, with the web extending between a supply roller and a take-up roller; and advancing the web while the face of the applicator nozzle is in contact with the web to constantly introduce a clean portion of the web on the face of the applicator nozzle and clean the face of the applicator nozzle.

The present invention further relates to a method of cleaning an applicator nozzle of a development cartridge which comprises the steps of: moving a face of an applicator nozzle of a development cartridge into contact with a web; and advancing the web while the applicator nozzle is in contact with the web to constantly introduce a clean portion of the web on the applicator nozzle and clean the applicator nozzle.

The present invention further relates to a maintenance device for an applicator nozzle of a development cartridge which comprises: a cleaning web supply reel operationally associated with a spring member that is adapted to apply a resistance torque on the supply reel; a cleaning web take-up reel operationally associated with a one-way clutch; and a cleaning web adapted to travel from the cleaning web supply reel to the cleaning web take-up reel, such that during a cleaning cycle an applicator nozzle to be cleaned is brought into contact with the cleaning web while the cleaning web is advanced in a direction from the cleaning web supply reel to said cleaning web take-up reel. During the cleaning cycle the one-way clutch permits a rotation of the cleaning web take-up reel in a winding direction to wind the cleaning web which is soiled as a result of contact with said applicator nozzle on the cleaning web take-up reel, and prevents a rotation of the cleaning web take-up reel having the soiled cleaning web thereon in an unwinding direction; and the spring member and one-way clutch keep at least a span of the cleaning web which contacts the face of said applicator nozzle at a minimum tension during the cleaning cycle.

The present invention further relates to a method of processing photographic media which comprises the steps of: placing an applicator nozzle of a development cartridge in an operating position and applying processing fluid from the applicator nozzle onto an exposed photographic media to initiate development of images on the exposed photographic media; moving a face of the applicator nozzle from the operating position to a cleaning position where the face of the applicator nozzle is into contact with a web of a cleaning device; and advancing the web while the face of the applicator nozzle is in contact with the web to constantly introduce a clean portion of the web on the face of the applicator nozzle and clean the face of the applicator nozzle.

The present invention further relates to a method of processing photographic media which comprises the steps of: placing an applicator nozzle of a development cartridge in an operating position and applying processing fluid from the applicator nozzle onto an exposed photographic media to initiate development of images on the exposed photographic media, wherein a processing cycle is defined by at least one application of processing fluid from said applicator nozzle to said photographic media; scanning the photographic media as the images are developed to create a digital representation of the images; at the end of the processing cycle, moving a face of the applicator nozzle from the operating position to a cleaning position where the face of the applicator nozzle is in contact with a cleaning web of a cleaning device, with the web being adapted to travel from a supply member to a take-up member; and advancing the web in a direction from the supply member to the take-up member while the face of the applicator nozzle is in contact with the web to constantly introduce a clean portion of the web on the face of the applicator nozzle and clean the face of the applicator nozzle.

The present invention further relates to a maintenance device for an applicator nozzle of a development cartridge which comprises: a cleaning mechanism comprising a cleaning web which is adapted to clean a face of an applicator nozzle of a development cartridge when the face of the applicator nozzle is brought into contact with said web; and a capping mechanism comprising a capping web adapted to seal the face of the applicator nozzle when the applicator nozzle is brought into contact with said capping web.

The present invention further relates to a maintenance device for an applicator nozzle of a development cartridge which comprises: a cleaning mechanism adapted to clean a face of an applicator nozzle of a development cartridge; and a capping mechanism adapted to seal the face of the applicator nozzle.

### BRIEF DESCRIPTION OF THE DRAWINGS

For a more complete understanding of the invention and the advantages thereof, reference is now made to the following description taken in conjunction with the accompanying drawings, wherein like reference numerals represent like parts, in which:

FIG. 1 is a block diagram of an improved digital film development system in accordance with the invention;

FIG. 2A is a block diagram illustrating a development system as shown in FIG. 1;

FIG. 2B is a side view in partial cross section of an applicator station incorporating a processing solution cartridge in accordance with the invention;

FIGS. 2C-1 through 2C-4 are block diagrams illustrating various embodiments of a processing station shown in FIG. 2A;

FIG. 3 shows a maintenance cartridge or device in accordance with the present invention;

FIGS. 4A-4F illustrate a cleaning cycle in accordance with the present invention;

FIG. 5A schematically illustrates a section of a capping web;

FIG. 5B illustrates a capping or sealing process in accordance with a further feature of the present invention;

FIG. 6 is an alternate method and device for capping or sealing an applicator nozzle in accordance with the present invention;

FIG. 7 is a further embodiment of the capping or sealing device of FIG. 6; and

FIGS. 8A-8B show a still further embodiment of a capping and sealing device in accordance with the present invention.

### DETAILED DESCRIPTION OF THE INVENTION

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

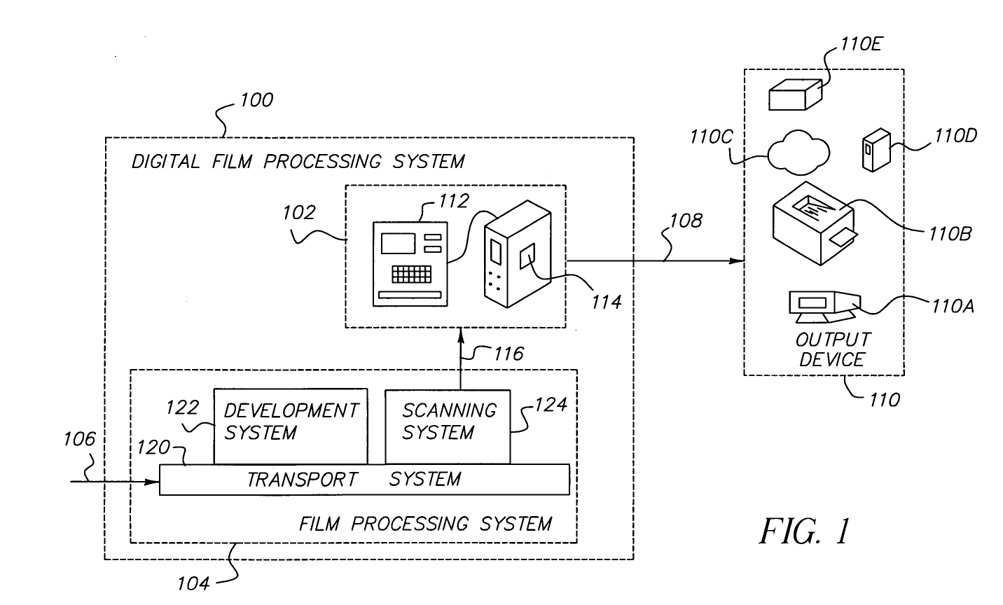

FIG. 1 is an example of one embodiment of a digital film development system 100. In this embodiment, the system 100 comprises a data processing system 102 and a film processing system 104 that operates to digitize a film or photographic media 106 to produce a digital image 108 that can be output to an output device 110. Film or photographic media 106, as used herein, includes color, black and white, x-ray, infrared or any other type of film and is not meant to refer to any specific type of film or a specific manufacturer.

Data processing system 102 comprises any type of computer or processor operable to process data. For example, data processing system 102 may comprise a personal computer manufactured by Apple Computing, Inc. of Cupertino, Calif., or International Business Machines of New York. Data processing system 102 may also comprise any number of computers or individual processors, such as application specific integrated circuits (ASICs). Data processing system 102 may include a user interface 112 operable to allow a user to input information into the system 100. The user interface 112 generally includes a display and a printer, but may also include such input devices as a keypad, point-of-sale device, voice recognition system, memory reading device such as a flash card reader, or any other suitable data input device.

Data processing system 102 includes image processing software 114 resident on the data processing system 102. Data processing system 102 receives sensor or scan data 116 from film processing system 104. Sensor data 116 is representative of the image data and silver in the film 106 at each discrete location, or pixel, of the film 106. The sensor data 116 is processed by image processing software 114 to produce the digital image 108. The specific embodiment of the image processing software 114 is dependent upon the embodiment of the film processing system 104, and in particular, the specific embodiment of the scanning system. In an embodiment in which metallic silver grains and/or silver halide remains within the film 106, the image processing software 114 operates to compensate for the silver in the film 106. For example, one embodiment of image processing software 114 comprises software based on U.S. Pat. No. 6,442,301 entitled Defect Channel Nulling, which is incorporated herein by reference. In this embodiment, any silver remaining in the film 106 is treated as a defect and each individual pixel color record is compensated to remove the effect of the silver. In an embodiment in which the metallic silver grains and silver halide have been modified to a substantially transparent silver compound, the film 106 may be scanned using only visible light without digitally compensating for any occlusions. Processing the film 106 without washing the silver from film 106 substantially reduces or eliminates the production of hazardous chemical effluents that are generally produced during conventional film processing methods. Although the image processing software 114 is described in terms of actual software, the image processing software 114 may be embodied as hardware, such as an ASIC. The color records for each pixel form the digital image 108, which is then communicated to one or more output devices 110.

Output device 110 may comprise any type or combination of suitable devices for displaying, storing, printing, transmitting or otherwise outputting the digital image 108. For example, as illustrated, output device 110 may comprise a monitor 110a, a printer 110b, a network system 110c, a mass storage device 110d, a computer system 110e, or any other suitable output device. Network system 118c may be any network system, such as the Internet, a local area network, and the like. Mass storage device 110d may be a magnetic or optical storage device, such as a floppy drive, hard drive, removable hard drive, optical drive, CD-ROM drive, and the like. Computer system 110e may be used to further process or enhance the digital image 108.

Film processing system 104 operates to electronically scan the film 106 to produce the sensor data 116. Light used to scan the film 106 may include light within the visible portion of the electromagnetic spectrum, light within the infrared portion of the electromagnetic spectrum, a combination of visible and infrared light, or any other suitable electromagnetic radiation. As illustrated, film processing system 104 comprises a transport system 120, a development system 122, and a scanning system 124. Although the system 100 is illustrated with a development system 122, alternative embodiments of the system 100 do not require the development system 122. For example, film 106 may have been preprocessed and not require the development process described below.

Transport system 120 operates to dispense and move the film 106 through the film processing system 104. In a preferred embodiment, the transport system 120 comprises a leader transport system in which a leader is spliced to the film 106 and a series of rollers advances the film 106 through the film processing system 104, with care taken that the image surface of the film 106 is not contacted. Similar transport systems 120 are found in film products manufactured by, for example, Noritsu Koki Co. of Wakayama, Japan, and are available to those in the art.

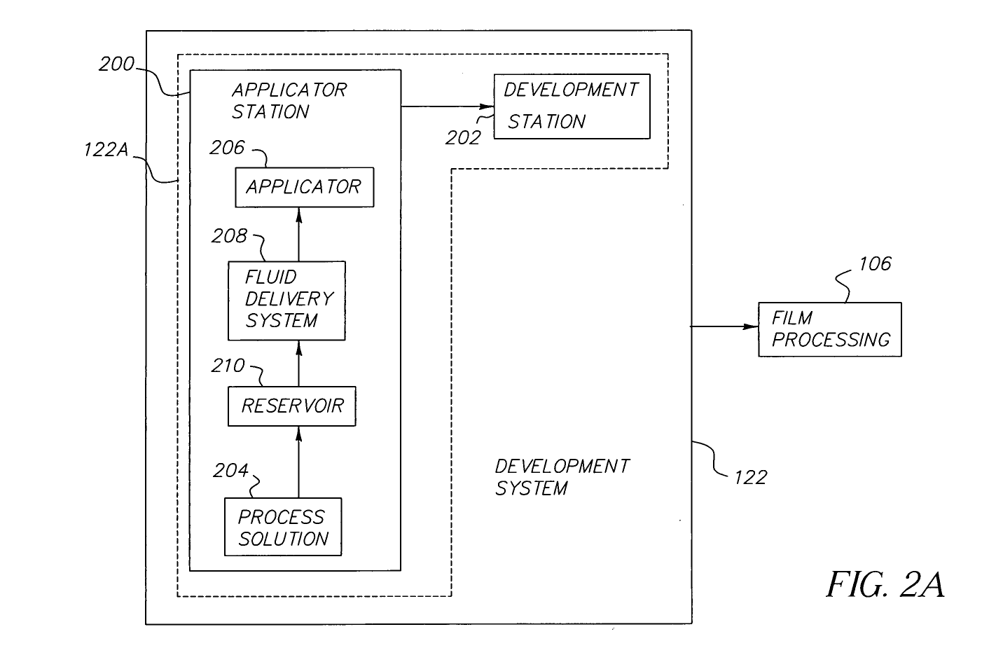

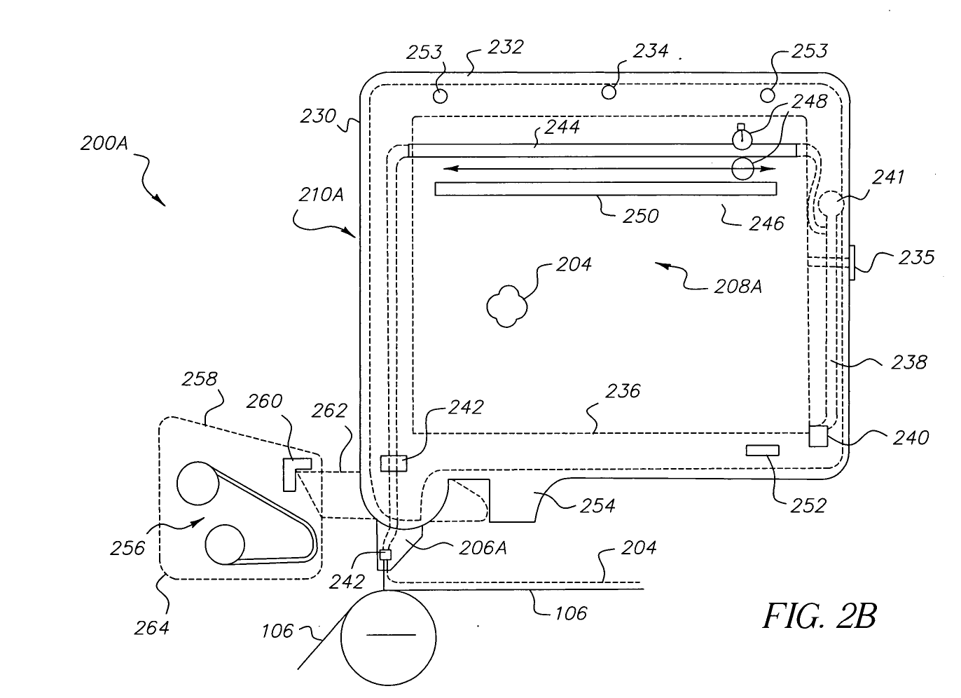

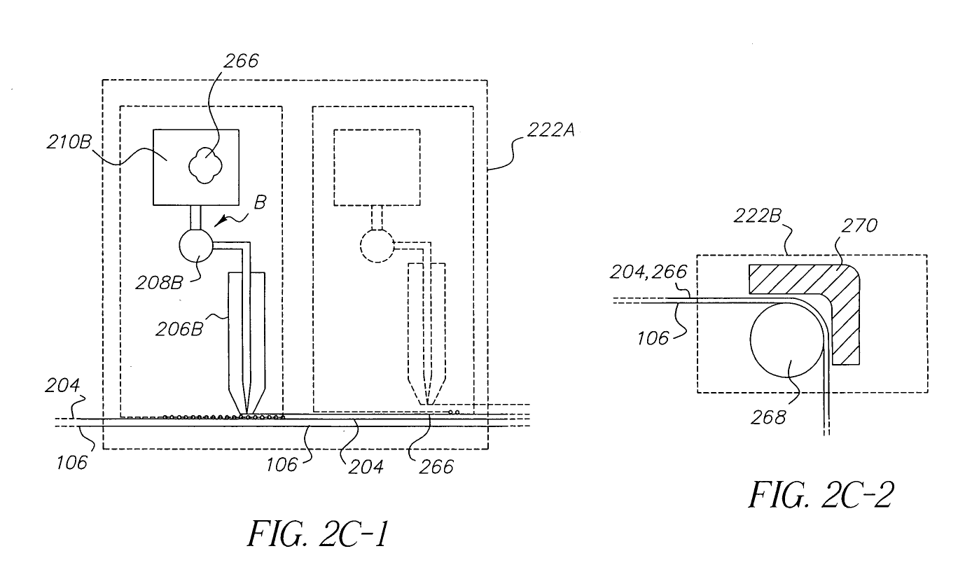

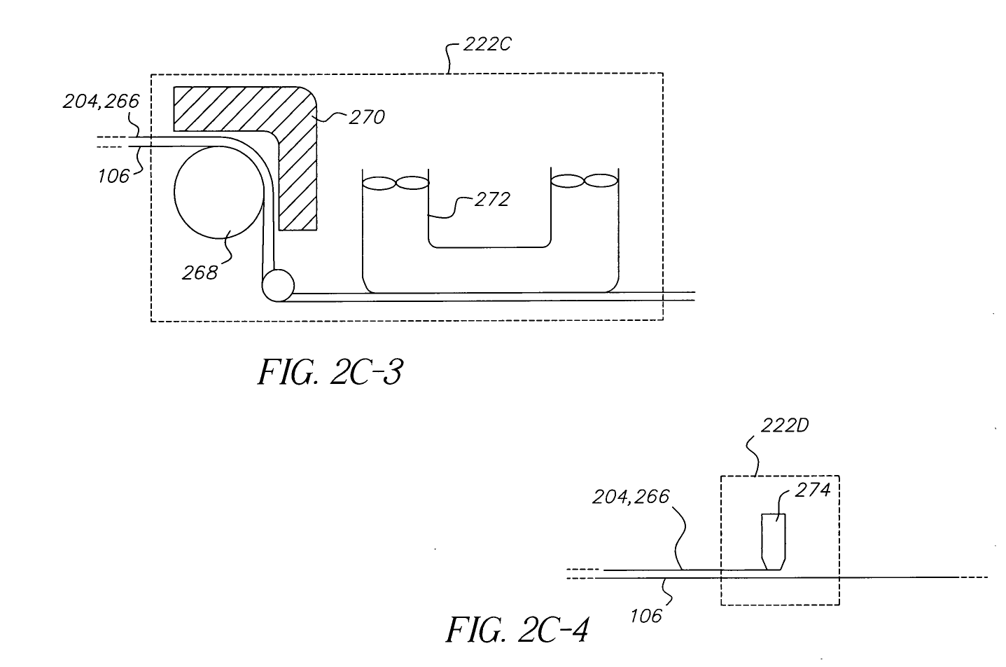

The development system 122 operates to apply one or more processing solutions or fluids to the film and develop the film 106, as described in greater detail in FIG. 2A. In the preferred embodiment, the processing solution comprises a viscous color developer solution that initiates production of the metallic silver grains and the magenta, cyan and yellow dye images within the film 106. In an alternative embodiment, the processing solution comprises a black and white developer solution that initiates production of the metallic silver grains within the film 106. The processing solution may include other suitable processing agents. The development system 122 may also apply other suitable processing solutions, such as a stop solution, inhibitors, accelerators, bleach solution, fixer solution, blix solution (combines the functionality of a bleach solution and a fixer solution), stabilizer solution and the like.

The scanning system 124 scans the film 106 through the processing solutions applied to the film 106. In other words, the processing solutions are not substantially removed from the film 106 prior to the scanning process. In contrast, conventional film processing systems wash the contaminated processing solutions and hazardous silver compounds from the film and then dry the film to create a conventional film negative prior to any digitization process. The scanning station 124 may comprise a number of different configurations depending, in part, on how the film 106 was developed. In general, specific colors of visible light interact with the dye images and any silver present in the film 106, and infrared light interacts with the silver in the film 106. In some embodiments of the development system 122, the silver (metallic silver and/or silver halide) is modified to reduce the optical effects of the silver. For example, a bleaching agent may be applied to the film 106. The bleaching agent operates to oxidize the metallic silver grains within the film 106 to produce silver halide. The silver halide has a lower optical density than the metallic silver grains. As a result, a greater amount of light is transmitted through the film 106. Another example is a fixing agent. A fixing agent dissolves the silver halide to produce a silver compound that is substantially transparent to light. As a result, light is readily transmitted through the film 106.

The scanning station 124 scans the film 106 using electromagnetic radiation and produces sensor data 116 representative of the film image data. In a preferred embodiment of the scanning station 124, the film 106 is scanned with light within the visible and/or infrared portions of the electromagnetic spectrum. The visible light measures the light intensity associated with the dye clouds as well as the silver within the film 106, and the infrared light measures the light intensity associated with the metallic silver grains within the film 106. In particular, one or more bands of visible light may be used to scan the film 106. For example, the film 106 may be scanned using visible light within the red, green and/or blue portions of the electromagnetic radiation spectrum. In other embodiments of the scanning station 124, the film 104 is scanned with only visible light, with only infrared light, with different combinations of visible light, or any other suitable electromagnetic radiation. The processing solutions are not substantially removed prior to scanning the film 106. In contrast, conventional film processing systems wash all the processing solutions and silver, both silver halide and metallic silver, from the film 106 prior to any conventional scanning processes. Silver, whether metallic silver or silver halide crystals, in the film negative interferes with the transmission of light through the film negative and would be digitized along with the image. Any silver in the film negative appears as defects in the resulting digital image. A specific description of different embodiments of scanning system architectures which can be utilized in the present invention are described in U.S. Pat. No. 6,599,036, the contents of which are herein incorporated by reference.

In operation, exposed, but undeveloped film 106 is fed into the transport system 120. The film 106 is transported through the development system 122. The development system 122 applies a processing solution to the film 106 that develops the film 106. The transport system 120 moves the film 106 through the scanning system 124. The scanning system 124 illuminates the film 106 with light. Light from the film 106 is measured by the sensor system, which produces sensor data 116. The sensor data 116 represents film image data in the film 106 at each pixel. The sensor data 116 is communicated to data processing system 102. The data processing system 102 processes the sensor data 116 using image processing software 114 to produce the digital image 108. The data processing system 102 may also operate to enhance or otherwise modify the digital image 108. For example, the digital image 108 may be modified in accordance with input from the user. The data processing system 102 communicates the digital image 108 to the output device 110 for viewing, storage, printing, communicating, or any combination of the above.

In a particular embodiment of the digital film development system 100 the system 100 is adapted to a self-service film processing system, such as a kiosk. Such a self-service film processing system is uniquely suited to new locations because no plumbing is required to operate the self-service film processing system. In addition, the developed images can be prescreened by the user before they are printed, thereby reducing costs and improving user satisfaction. In addition, the self-service film processing system can be packaged in a relatively small size to reduce the amount of floor space required. As a result of these advantages, a self-service film processing system can be located in hotels, college dormitories, airports, copy centers, or any other suitable location. In other embodiments, the system 100 may be used for commercial film lab processing applications. Again, because there is no plumbing and the environmental impact of processing the film 106 is substantially reduced or eliminated, the installation cost and the legal liability for operating such a film lab is reduced. The system 100 can be adapted to any suitable application without departing from the scope and spirit of the invention.

FIG. 2A illustrates one embodiment of the development system 122. In this embodiment, a development system 122A comprises an applicator station 200 and a development station 202. The applicator station 200 operates to apply a relatively uniform coating of a processing solution 204 to the film 106. In one embodiment, the processing solution 204 comprises a color developer solution, such as Flexicolor Developer for Process C-41 available from the Eastman Kodak Company. In other embodiments, the processing solution 204 comprises other suitable solutions. For example, the processing solution 204 may comprise a monobath solution that acts as a developer and stop solution.

The applicator station 200 generally includes an applicator, nozzle or applicator nozzle 206, a fluid delivery system 208, and a reservoir 210. The reservoir 210 includes a sufficient volume of processing solution 204 to process multiple rolls of film 106. As described in greater detail below, the reservoir 210 is refillable or replaceable within the development system 122 and preferably comprises a closed system that substantially prevents air and other contaminates from contacting the processing solution 204. In one embodiment, the reservoir 210 comprises a flexible bladder or bag that collapses as the processing solution 204 is dispensed. In this manner, air is not introduced into the reservoir 210 and the processing solution 204 is not contaminated by the air or other contaminates.

The reservoir 210 generally includes a fluid level indicator for determining the quantity of processing solution 204 remaining within the reservoir 210 or when additional processing solution 204 is required. In a preferred embodiment, the fluid level indictor comprises an electronic device, such as an electronic programmable read only memory (EPROM) chip. In this embodiment, the EPROM chip tracks the quantity of processing solution 204 dispensed from the reservoir 210. In this manner, the timing for replenishing the reservoir 210 with processing solution 204, or replacing the reservoir 210 can be easily determined. In another embodiment, the fluid level indicator comprises a collapsible bellows within the fluid path between the reservoir 210 and the applicator 206. A sensor switch senses the collapsing bellows and activates a pump to refill the bellows from the reservoir 210. A reservoir sensor then senses when the fluid level of the reservoir 210 is low and activates an operator warning signal to have the reservoir 210 refilled. In this manner, the fluid path is primed with processing solution 204 at all times, even when being refilled. In yet another embodiment, the fluid level indicator comprises a spring activated lever that engages a collapsible bladder containing the processing solution 204. In this embodiment, the position of the lever is sensed and when reaching a certain position indicating a low level of processing solution 204, an operator warning signal is produced to have the reservoir 210 refilled or replaced. The fluid level indicator may comprise other suitable devices, such as a site glass, sand pipe indicator, metering system, and the like.

In an embodiment in which the reservoir 210 is permanently fixed within the development system 122, the reservoir 210 comprises a container that can be refilled with processing solution 204. In an embodiment in which the reservoir 210 is replaceably attached within the development system 122, the reservoir 210 preferably comprises a housing or cartridge having an internal chamber operable to contain the processing solution 204. In this embodiment, the housing preferably includes one or more locating features that allows the reservoir 210 to be precisely located within the development system 122. The locating features may also be used to facilitate securing the reservoir 210 within the development system 122.

The fluid delivery system 208 communicates the processing solution 204 from the reservoir 210 to the applicator 206. The fluid delivery system 208 generally delivers the processing solution 204 at a constant volumetric flow rate to help insure uniformity of coating of processing solution 204 on the film 106. In the preferred embodiment, the fluid delivery system 208 comprises a peristaltic pump. In this embodiment, a tube filled with the processing solution 204 is compressed and the area of compression is moved to push the processing solution 204. This embodiment has the advantage that the processing solution 204 does not come into contact with any mechanical pumping device and a portion of the fluid delivery system comprises a portion of the fluid delivery system 208. In another embodiment, the fluid delivery system 208 includes a compressed air source that provides air to a sealed housing containing a collapsible bladder containing the processing solution 204. In this embodiment, the air pressure within the housing pressurizes the processing solution 204 to communicate the processing solution 204 from the reservoir 210 to the applicator 206. The fluid delivery system 208 may comprise other suitable pumping devices without departing from the invention. For example, the fluid delivery system 208 may comprise a piston operable to apply pressure to the reservoir 210, a centrifugal pump, a reciprocating pump, and the like.

The applicator 206 operates to apply the processing solution 204 onto the film 106. In a preferred embodiment, the applicator 206 comprises a slot coat device or nozzle operable to apply a coating of processing solution 204 onto the film 106. This embodiment is preferable because the processing solution 204 is applied evenly to allow scanning to take place through the coated film 106. The applicator 206 may comprise other suitable devices for applying the processing solution 204 to the film 106. For example, applicator 206 may comprise a fluid jet applicator, a drip applicator, and the like.

The applicator station 200 may further include a cleaning system, device or station operable to clean the face of applicator 206. In the preferred embodiment, the cleaning system includes a roll of a tape cleaner that contacts the applicator 206 as the applicator 206 pivots to wipe any excess processing solution 204 from the applicator 206. The tape cleaner absorbs the processing solution 204 and prevents the processing solution 204 from drying on the applicator 206. In another embodiment, the cleaning system operates in conjunction with the fluid delivery system 208. In this embodiment, the fluid delivery system 208 is reversed and any excess processing solution 204 is sucked back into the applicator 206.

The applicator station 200 may also include a capping station or device operable to substantially seal the face of applicator 206 when the applicator station 200 is not in use. As described earlier, air operates to dry and contaminate the processing solution 204. The capping station has the advantage of preventing air and other contaminates from entering the applicator 206. In the preferred embodiment, the applicator 206 pivots to contact a seal after the applicator 206 is cleaned by the cleaning system.

The applicator 206 and reservoir 210 are preferably integrated into a replaceable processing solution cartridge, as described in greater detail in FIG. 2B. In a particular embodiment, the applicator 206 is movably attached to the reservoir 210. In the preferred embodiment, the applicator 206 is pivotally attached to the reservoir 210. This embodiment allows the applicator 206 to be pivoted to contact the cleaning system or device and the capping system or device. An advantage of the replaceable processing solution cartridge is that the entire fluid path of the processing solution 204 is replaced at regular intervals. Similarly, the cleaning system or device and the capping system or device may be integrated into a replaceable maintenance cartridge.

The applicator station 200 may comprise other suitable devices and systems without departing from the invention. An embodiment of the applicator station 200 includes a processing solution cartridge as more fully described in FIG. 2B.

The development station 202 operates to give the film 106 time to develop prior to being scanned by the scanning system 124. In the embodiment illustrated, the development station 202 forms that portion of the transport system 120 between the applicator 206 and the scanning system 124. The length of the development station 202 is generally dependent upon the development time of the film 106. In particular, depending upon the environment and chemical nature of the processing solution 204, development of the film 106 may require as little as a few seconds to as long as several minutes.

The development station 202 may comprise a cover that protects the film 106 during development. The cover forms an environmental chamber surrounding the film 106. The temperature and relative humidity within the environmental chamber are strictly controlled. To facilitate controlling the temperature and relative humidity, the environmental chamber can have a minimum volume surrounding the film 106. The cover may be insulated to maintain a substantially constant temperature as the film 106 is developed. In order to maintain the temperature, the development station 202 can include a heating system. The heating system may include a heated roller provided in the conveying path of the film and/or a heating element. The heating system may also include a processing solution heating system that heats the processing solution 204 prior to its application to the film 106.

In operation, transport system 120 transports the film 106 through the applicator station 200. Fluid delivery system 208 dispenses the processing solution 204 from the reservoir 210 through the applicator 206 onto the film 106. The processing solution 204 initiates development of the dye image and silver image within the film 106. The coated film 106 is then transported through the development station 202. As discussed above, the development station 202 allows the film 106 time to develop within a controlled environment. In an alternative embodiment, the film 106 is then transported through the processing station 222 where the film 106 is further processed. The film 106 is then transported by the transport system 120 to the scanning system 124. As described above, the processing solution 204 coated on the film 106 is not removed, but remains on the film 106 as the film 106 is transported to the scanning system 124.

FIG. 2B illustrates an applicator station 200A incorporating a replaceable processing solution cartridge 230. In one embodiment, the cartridge 230 comprises a housing 232 and a chamber 234 operable to contain the processing solution 204. The housing 232 is generally fabricated in multiple pieces that are fastened together. The housing 232 is preferably fabricated from an injection-molded plastic, such as an ABS, PVC, Polypropylenes, and polystyrene.

As an example and with reference to FIG. 2B, applicator station 200A may include a cleaner system, device or station 256 operable to clean an applicator, applicator nozzle or applicator nozzle face 206A. In one embodiment, the cleaner system 256 comprises a tape or web cleaner 258 having a roll of absorbent material. In this embodiment, the applicator 206A pivotally engages the tape or web cleaner 258 and wipes any excess processing solution 204 from the applicator 206A. The absorbent material advances after cleaning the applicator or applicator nozzle face 206A. It is noted that applicator nozzle 206A can be mounted in a known manner so as to be pivotal, movable or rotatable between a plurality of positions including an operating position where nozzle 206A applies fluid to photographic media, a cleaning position for cleaning the nozzle, and a capping or sealing position for sealing the nozzle.

The applicator station 200A may further include capping station, device or system 260 operable to substantially seal the applicator 206A when the system 100 is not in use. In one embodiment, the capping station 260 comprises an absorbent seal 262 operable to pivotally engage the applicator 206A. The applicator 206A generally engages the capping station 260 after being cleaned by the cleaner system 256. The capping station 260 may comprise other suitable devices for substantially sealing the applicator 206A between periods of use.

In one embodiment, the cleaner system 256 and capping station 260 are integrated into a single maintenance cartridge or device 264. This allows simple replacement of the cleaner system 256 and replenishment of the tape cleaner 258. Similar to the processing solution cartridge 230, the maintenance cartridge or device 264 may be fabricated from injection molded plastic components fastened together with the components for the cleaner system 256 and the capping station 260. The maintenance cartridge or device 264 may comprise other suitable devices without departing from the scope of the present invention.

Referring to FIG. 2B, housing 232 may include one or more locating features 233 that match complementary features (not expressly shown) within the applicator station 200a. The locating features 233 facilitate the installation of the cartridge 230 into the development system 122 and operate to reduce installation errors by operators. The locating features 233 may also operate to secure the cartridge 230 within the applicator station 200a. The chamber 234 contains a sufficient quantity of processing solution 204 to coat multiple rolls of film 106. In a particular embodiment, the cartridge 230 includes a refill device 235 that allows the cartridge 230 to be refilled with processing solution 204.

In a particular embodiment, the cartridge 230 also includes a collapsible bladder or bag 236 disposed within the chamber 234. The collapsible bladder 236 contains the processing solution 204 and removes the need for the housing 232 to be a sealed container. The collapsible bladder 236 also allows the cartridge 230 to be easily recycled by replacing a collapsed bladder 236 with a full collapsible bladder 236.

In yet another embodiment, the cartridge 230 also includes a fluid communication system 238. The fluid communication system 238 communicates the processing solution 204 from the chamber 234 to the applicator 206. The fluid communication system 238 generally comprises flexible tubing. In a particular embodiment, the fluid communication system 238 includes a shuttle valve 240. In this embodiment, the shuttle valve 240 opens to allow the processing solution 204 to flow through the fluid communication system 238 when the cartridge 230 is installed in the development system 122. This provides a safety feature to prevent the premature or accidental discharge of the processing solution 204. The fluid communication system 238 may also include a bubble capture device 241. An air bubble communicated to the applicator 206 results in a discontinuity of the processing solution 204 coated onto the film 106. Discontinuities may cause imperfections in the development of the film 106. The bubble capture device 241 operates to prevent air bubbles from being communicated to the applicator 206. The fluid communication system 238 may also include a valve 242 proximate the applicator 206. The valve 242 is generally a unidirectional valve that operates to prevent contaminates or the processing solution 204 from entering the fluid communication system 238.

In an embodiment of the cartridge 230, the fluid communication system 238 includes tubing 244 that can be acted upon by a peristaltic pump 246. The peristaltic pump 246 generally forms a portion of the applicator station 200a, but does not form a portion of the cartridge 230. As illustrated, the peristaltic pump 246 comprises rollers 248 coupled to a carriage 250. The rollers 248 operate to compress the tubing 244 and the carriage 250 moves parallel to the tubing 244. As illustrated, to pump the processing solution 204 from the chamber 234 toward the applicator 206, the carriage 250 is in a far right position and rollers 248 compress the tubing 244. While the rollers 248 maintain compression of the tubing 244, the carriage 250 moves toward to left, thereby pushing the processing solution 204 toward the applicator 206. Upon reaching the far left position, the rollers 248 release the tubing 244 and the carriage 250 moves the rollers 248 back toward the far right position. In the preferred embodiment, the quantity of processing solution 204 dispensed by a single cycle of the peristaltic pump 246 corresponds generally to the quantity of processing solution 204 needed to process a single roll of film 106.

The cartridge 230 may include a fluid level indicator 252. In the preferred embodiment, the fluid level indicator 252 comprises an electronic device, such as an EPROM. In an embodiment using a peristaltic pump 246, the EPROM can be continuously updated with information relating to how many cycles the peristaltic pump 246 has been activated, and accordingly the quantity of processing solution 204 remaining within the cartridge 230. This embodiment also allows the cartridge 230 to be removed and reinstalled without losing the fill data. The fluid level indicator 252 may comprise other suitable devices without departing from the invention.

The cartridge 230 may also include an integral applicator 206A. In the preferred embodiment, the applicator 206A is pivotally coupled to the housing 232. In particular, the cartridge 230 may include docking station 254. In the preferred embodiment, the docking station 254 allows the applicator 206A to be locked in place during shipment of the cartridge 230, thereby reducing the possibility of damaging the applicator 206A. Although the applicator 206A is illustrated as being pivotally attached to the housing 232, the applicator 206A may be otherwise suitably coupled to the housing 232. For example, the applicator 206A may be fixed to the housing 232, slidably attached to the housing 232, or otherwise suitably attached to the housing 232.

FIG. 2C-1 illustrates an example of a processing station 222A that operates to apply one or more processing solutions 266 to the film 106. As illustrated, the processing station 222A comprises an applicator 206B, a fluid delivery system 208B, and a reservoir 210B, similar in function and design as applicator station 200 described in FIG. 2A. Although a single applicator 206B, fluid delivery system 208B, and reservoir 2101B is illustrated, the processing station 222A may comprise any number of applicators 206B, fluid delivery systems 208B, and reservoirs 210B that apply other suitable processing solutions 266 and other suitable solutions.

The processing solution 266 may comprise any suitable chemical applied to the film 106 to further process the film 106. In one embodiment, the processing solution 266 includes a fixer solution. As discussed previously, the fixer solution dissolves the silver halide into a substantially transparent silver compound. This has the effect of slightly reducing the opacity of the film 106, but substantially eliminating the sensitivity of the film 106 to any type of light. In another embodiment, the processing solution 266 includes a bleaching agent. The bleaching agent converts the metallic silver within the film 106 into silver halide. As a result, the opacity of the film 106 is greatly reduced, but the sensitivity of the film 106 to light is not substantially reduced. In yet another embodiment, both a bleaching agent and a fixing agent are applied to the film 106, or a single blix solution (combines functions of a bleaching agent and fixing agent). This has the effect of substantially reducing the opacity of the film 106 and also substantially reducing the sensitivity of the film 106 to light. The processing solution 266 may also include an aqueous solution, stopping agents, stabilizing agents, or any other suitable film processing agent or solutions without departing from the scope of the invention.

FIG. 2C-2 illustrates an example of a processing station 222B that operates to chill the developing film 106. Chilling the developing film 106 substantially slows the chemical developing action of the processing solution 204. In the embodiment illustrated, the processing station 222B comprises an electrical cooling roller 268 and insulation shield 270. In this embodiment, the cooling roller 268 is electronically maintained at a cool temperature that substantially arrests the chemical reaction of the processing solution 204. The insulation shield 270 substantially reduces the heat transfer to the cooling roller 268. The processing station 222B may comprise any other suitable system and device for chilling the developing film 106.

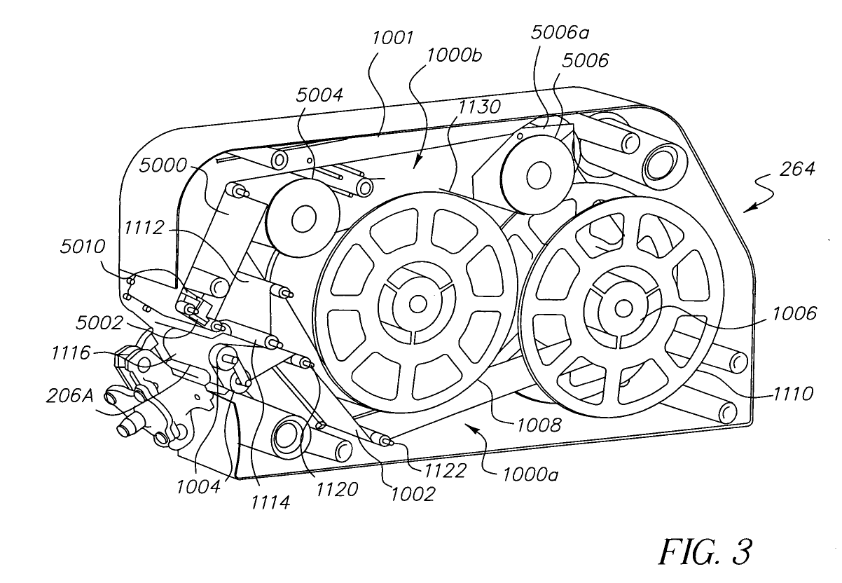

FIG. 2C-3 illustrates an example of a processing station 222C that operates to dry the processing solution 204 on the coated film 106. Drying the processing solution 204 substantially stops further development of the film 106 and may also decrease the opacity of the film 106. In the embodiment illustrated, the processing station 222C comprises an optional cooling roller 268, as described in FIG. 2C-2, and a drying system 272. Although heating the coated film 106 would facilitate drying the processing solution 204, the higher temperature would also have the effect of accelerating the chemical reaction of the processing solution 204 and film 106. Accordingly, in the preferred embodiment, the film 106 is cooled to retard the chemical action of the processing solution 204 and then dried to effectively freeze-dry the coated film 106. Although chilling the film 106 is preferred, heating the film 106 to dry the film 106 can also be accomplished by incorporating the accelerated action of the developer solution 204 into the development time for the film 106. In another embodiment in which a suitable processing solution 266 is applied to the film 106, the chemical action of the processing solution 204 is already minimized and the film 106 can be dried using heat without substantially effecting the development of the film 106. As illustrated, the drying system 272 circulates air over the film 106 to dry the processing solution 204 and depending upon the embodiment, the processing solution 266. The processing station 222C may comprise any other suitable system for drying the film 106.

FIG. 2C-4 illustrates an example of a processing station 222D that operates to substantially remove excess processing solution 204, and any excess processing solution 266, from the film 106. The processing station 222D does not remove the solutions 204, 266 that are absorbed into the film 106. In other words, even after the wiping action, the film 106 includes some processing solutions 204, 266. Removing any excess processing solution 204 will retard the continued development of the film 106. In addition, wiping any excess processing solutions 204, 266 from the film 106 may improve the light reflectance and transmissivity properties of the coated film 106. In particular, removal of the excess processing solutions 204, 266 may reduce any surface irregularities in the coating surface, which can degrade the scanning operation. In the embodiment illustrated, the processing station 222D comprises a wiper 274 operable to substantially remove excess processing solution 204 and any processing solution 266. In a particular embodiment, the wiper 274 includes an absorbent material that wicks away the excess processing solutions 204, 266. In another embodiment, the wiper 274 comprises a squeegee that mechanically removes substantially all the excess processing solutions 204, 266. The processing station 222D may comprise any suitable device or system operable to substantially remove any excess processing solutions 204, 266.

Although specific embodiments of the processing station (222A-222D) have been described above, the processing station 222A-222D may comprise any suitable device or system for further processing the film 106. In particular, the processing station 222A-222D may comprise any suitable combination of the above embodiments. For example, the processing station 222A-222D may comprise an applicator station 200B for applying a processing solution 224, a cooling roller 268, and a drying system 272. As another example, the processing station 222A-222D may comprise a wiper 274 and a drying system 272.

A maintenance cartridge or device 264 in accordance with the present invention will now be described with reference to FIG. 3. The maintenance device 264 comprises two primary systems, a cleaning system, mechanism, device, or station 1000a and a capping (sealing) system, mechanism, device or station 1000b.

The cleaning system 1000a comprises an absorbent web material or web 1002 that is moved in such a way as to wipe off excess fluid from the face of applicator or applicator nozzle 206A. The cleaning system further comprises a set of spring-loaded rollers or wipers 1004 that progressively direct the web 1002 across the face of the applicator nozzle that needs to be cleaned. As shown in FIG. 3, cleaning system 1000a further includes a cleaning web supply reel, roller or member 1008 and a cleaning web take-up reel, roller of member 1110. Therefore, cleaning web 1002 can be advanced from supply reel 1008, past guiding rollers 1112, 1114 and to cleaning rollers 1004, where a span 1116 of the web 1002 that opposes the face of the applicator nozzle is created. Thereafter, the web is advanced by further guiding rollers 1120 and 1122 and wound on take-up reel 1110. After cleaning applicator nozzle 206A in a manner which will be described, soiled web is essentially wound on take-up reel 1110.

In addition to the above, the geometry of the applicator nozzle 206A can be designed to interact with the shape of the rollers or wipers 1004 to create the desired cleaning progression, and to ensure that any remaining fluid residue is left well outside of the coating region of applicator nozzle 206A. A cleaning cycle utilizing the cleaning system 1000a noted above includes a variety of motions designed to fully sweep the remaining fluid residue from the face and sides of the nozzle 206A.

The drive for the maintenance cartridge or device 264 is designed with a one-way clutch 1006 operationally associated with take-up reel 1110 that is adapted to allow the soiled web take-up reel 1110 to advance in a manner that winds up the soiled web, but will not allow that reel 1110 to unwind. The supply reel 1008 for the cleaning web is restricted from freely turning by use of a drag spring 1130 that produces a certain resistance torque on the reel 1008. As an option, drag spring 1130 can further be a flat spring plate that can be mounted on the cover of device or cartridge 264. This combination allows the web 1002 to be kept at a desired minimum tension during a web cleaning cycle.

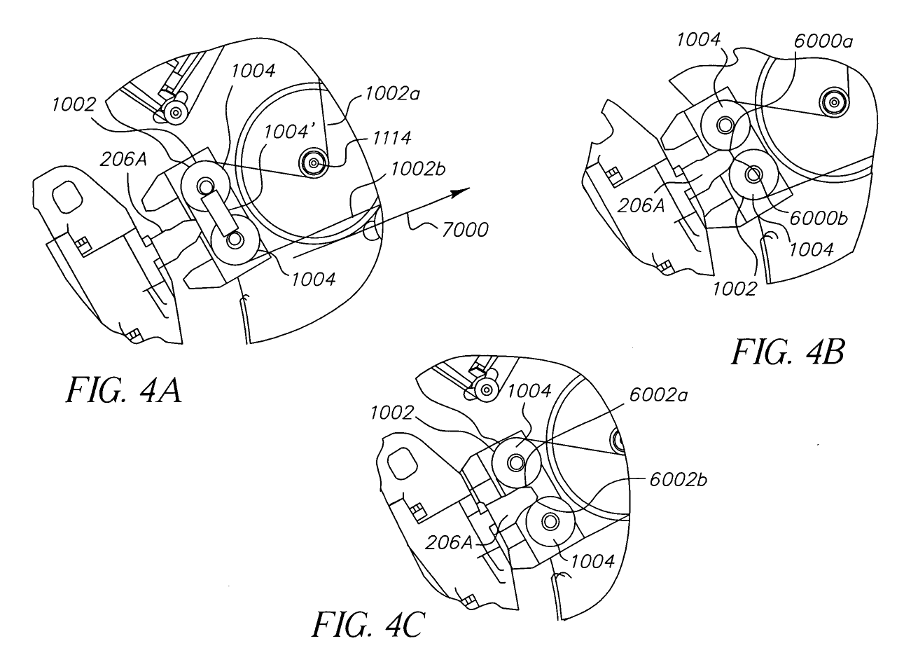

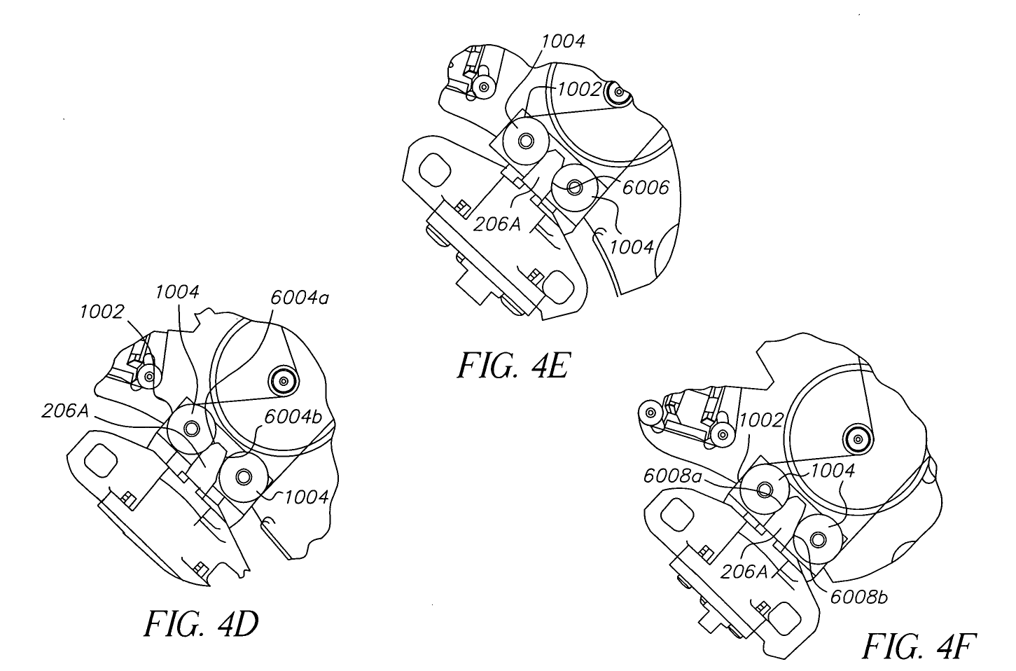

The web cleaning cycle will be described with reference to FIGS. 4A-4F. The cleaning cycle includes bringing the nozzle face 206A into contact with the taut web 1002 and particularly the span 1116 of the web 1002 as positioned across the cleaning rollers 1004 (FIG. 4A), and then thrusting the nozzle 206A between the rollers 1004 at a controlled rate (FIG. 4B). While the nozzle 206A is moving between the rollers 1004, the web 1002 is either advanced by rotation of the take-up reel 1110, or clean web is presented to the nozzle 206A by action of the one-way clutch 1006 and the drawing of web from the supply reel 1008. As the nozzle 206A strokes to its fully engaged position (FIG. 4F), the web 1002 is drawn over the critical faces of the nozzle 206A, constantly introducing clean web 1002 on the leading side, and moving it toward the trailing side. This thrusting cycle is completed and then the nozzle is drawn back along the same path as the web is continuously advanced. The cycle is repeated as often as needed to ensure full cleaning of the nozzle faces.

Note the fit between the sides of the nozzle and the rollers is such that any fluid residue is left far from the nozzle face, with relatively little motion of the cleaning web. This allows effective cleaning with minimal use of the web material. As shown in FIG. 4A, nozzle 206A is first brought into contact with web 1002 spanning between cleaning rollers 1004 which can be spring loaded such that a spring 1004′ is located between rollers 1004. As also shown in FIG. 4A, unused cleaning web 1002a is advanced from supply reel 1008 in direction 7000. During the full cleaning cycle (for example, in the stages shown in FIGS. 4A-4F), the web 1002 is constantly advanced to introduce clean or unused web 1002a on the applicator nozzle 206A and wind soiled web 1002b onto take-up reel 1110.

In FIG. 4B, nozzle 206A is shown further engaged between rollers 1004 while in contact with advancing web 1002. The position illustrated in FIG. 4B is effective to wipe a leading corner 6000a and a trailing corner 6000b of nozzle 206A.

In FIG. 4C, the nozzle 206A is moved further between rollers 1004 while in contact with advancing web 1002. The position in FIG. 4C is effective to clean or wipe a leading first face 6002a of nozzle 206A and clean or wipe a trailing first face 6002b of nozzle 206A.

In FIG. 4D, the nozzle 206A is moved still further between rollers 1004 while in contact with advancing web 1002. The position in FIG. 4D is effective to clean or wipe a leading curved face 6004a of nozzle 206A and clean or wipe a trailing curved face 6004b of nozzle 206A.

In FIG. 4E, the nozzle 206A is moved still further between rollers 1004 while in contact with advancing web 1002. The position in FIG. 4E is effective to clean or wipe a trailing exit face 6006 of nozzle 206A.

In FIG. 4F, the nozzle 206A is moved still further between rollers 1004 while in contact with advancing web 1002. The position in FIG. 4F is effective to fully wipe leading face 6008a of nozzle 206A and wiped debris fully to the corner of the trailing face 6008b of nozzle 206A.

The capping station, system or mechanism 1000b includes a renewable two-layer web 5000 and a compliant backup pad 5002. The web 5000 is supplied from an unused web supply reel 5004, threaded through the cartridge or device 1000 so as to lie over the backup pad 5002, and then to a take-up reel 5006 for the used web 5000.

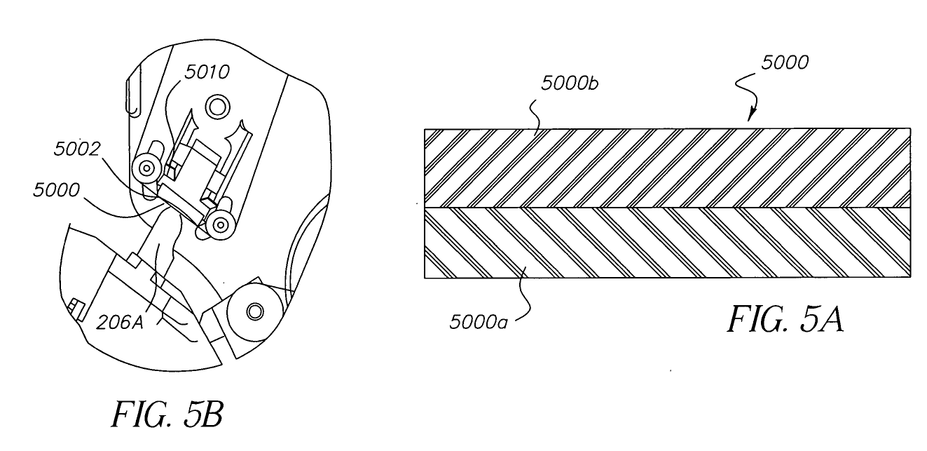

As schematically illustrated in FIG. 5A which shows a section of capping web 5000, capping web 5000 is composed of a carrier layer 5000a which is thin, somewhat compliant yet stiff enough to bear the tension of advancing and guiding the web without excessive stretching, and of low permeability, and a sealing layer 5000b which is highly conformable to the applicator nozzle face 206A, and which may have adhesive properties.

The sealing layer 5000b is used to seal the face of the nozzle 206A to prevent the fluid from drying out.

The addition of adhesive properties to the sealing layer 5000b helps ensure that any particulate matter is left on the capping web 5000 when the nozzle 206A is removed from the capping station 1000b.

In a feature of the device or cartridge 264 of the present invention, in order to prevent capping web 5000 from sticking to unwanted areas of the device 264, surfaces of device 264, such as surface 1001 in proximity to capping web 5000 can be textured. The texture minimizes surface contact and eliminates sticking. As an alternative, a release agent can be used on those surfaces in proximity to capping web 5000.

The backup pad 5002 is made of an elastomeric material ranging in thickness from 0.5 mm to 10 mm, and with a hardness as measured on the Shore A scale of between 10 and 90. The noted ranges are examples and can be modified based on design considerations.

The backup pad 5002 is mounted on an articulated rocker shoe 5010 that allows the pad 5002 to tilt as needed to provide uniform sealing pressure across the face of the nozzle 206A as the nozzle 206A is pressed into the pad 5002.

As illustrated in FIG. 5B, during a sealing stage, the nozzle 206A is pressed into the sealing web 5000 and backup pad 5002 with a force adequate to prevent air leakage paths along the face of the nozzle 206A. In a preferred embodiment, this force is between 0.5 pounds and 10 pounds depending on the composition of the web and backup pad. This results in sealing pressures on the face of the nozzle 206A ranging from 5 to 100 PSIG. The note range is an example and can be modified based on design considerations.

The compliant nature of the sealing layer 5000b is such as to fill the micro-pits and surface roughness of the face of the nozzle 206A. This provides an effective air (oxygen) leakage barrier.

In typical use, the nozzle 206A is first cleaned at cleaning device 1000a as described above, then presented to the capping device 1000b. For this purpose the nozzle 206A could be pivoted from an operating position to the cleaning position, and then to the capping or sealing position by mounting nozzle 206A on a known mechanism to permit a pivoting of the nozzle 206A. For sealing or capping, the capping web 5000 is indexed a required distance prior to placement of the nozzle 206A into the capping pad region as shown in FIG. 5. This index presents a fresh piece of capping web 5000 to the nozzle 206A for best sealing. Typical indexes are on the order of 2 to 3 times the width of the nozzle face 206A. In order to help guide the capping web 5000 onto the capping web take-up reel 5006, a guide plate 5006a can be used on one or both sides of take-up reel 5006. This prevents crinkling of the windup and prevents pre-mature filling of reel 5006.

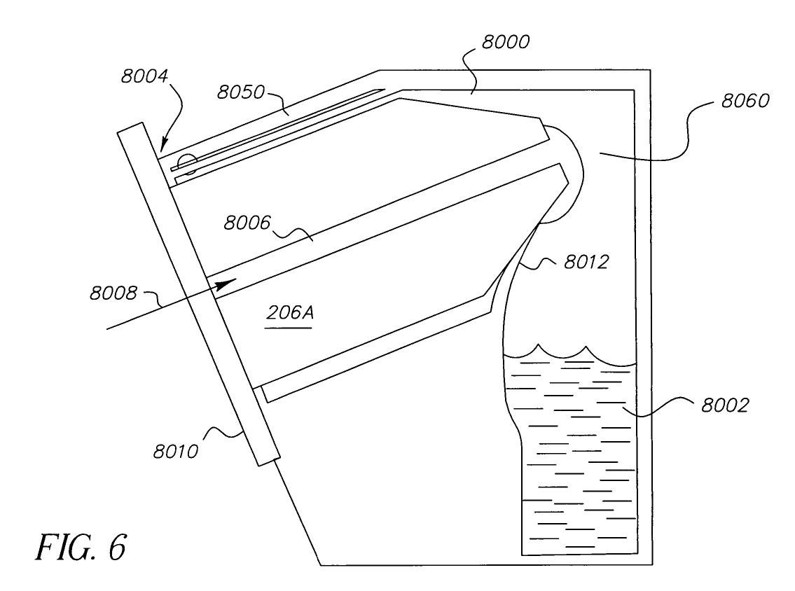

An alternate capping system and method is shown in FIG. 6. The alternate system and method comprises a small chamber 8000 in which the applicator nozzle tip 206A is inserted (see arrow 8008), a fluid reservoir 8002, and a sealing surface 8004.

When the nozzle 206A is engaged as shown in FIG. 6, a door 8050 can be opened by insertion action of nozzle 206A. The fluid reservoir 8002 maintains 100% saturation of the small volume of air 8060 to prevent drying of the nozzle tip. The reservoir 8002 can be replenished by dispensing a small amount of fluid from the nozzle 206A.

The fluid in the reservoir 8002 could also be used to submerge the tip of the nozzle 206A to prevent drying inside slot 8006 of nozzle 206A. Any potential drying will occur on the exterior of the nozzle 206A where it is easily cleaned.

The sealing surface 8004 mates with a base 8010 of the nozzle tip 206A making an air tight seal at this interface. This interface remains clean because it has contact surfaces that do not encounter fluid.

The capping system of FIG. 6 will divert fluid from the tip of nozzle 206A into the reservoir 8002. This could be done in many ways including the following examples. Using a wetting surface or absorbent material in close proximity to the tip of nozzle 206A to attract fluid away from the nozzle and guide it into the reservoir 8002; or using a small weir 8012 pressed against the bottom side of the tip of the nozzle 2006A to divert fluid into the reservoir 8002. Because the nozzle tip does not have a mating surface, it can be sealed immediately after coating, but a cleaning step should precede the next cycle. This alternative method does not require a web or web path.

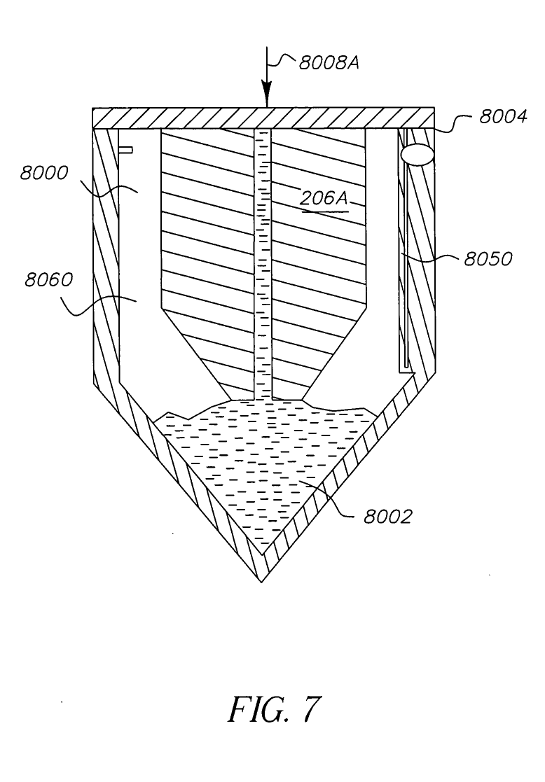

FIG. 7 illustrates a further embodiment of the capping or sealing system as shown in FIG. 6. In the embodiment of FIG. 7, chamber 8000 has a different orientation. When the tip of nozzle 206A is inserted in direction 8008A into chamber 8000, mechanical door 8050 is forced open and the tip of the nozzle 206A is positioned as shown in FIG. 7. Sealing surface 8004 will be formed as shown and the fluid in reservoir 8002 could be used to submerge the tip of nozzle 206A. As in the embodiment of FIG. 6, the fluid reservoir is adapted to maintain a small volume of air 8060 in chamber 8000 100% saturated. Therefore, the system of FIG. 7 is similar to the system of FIG. 6 but has a different orientation.

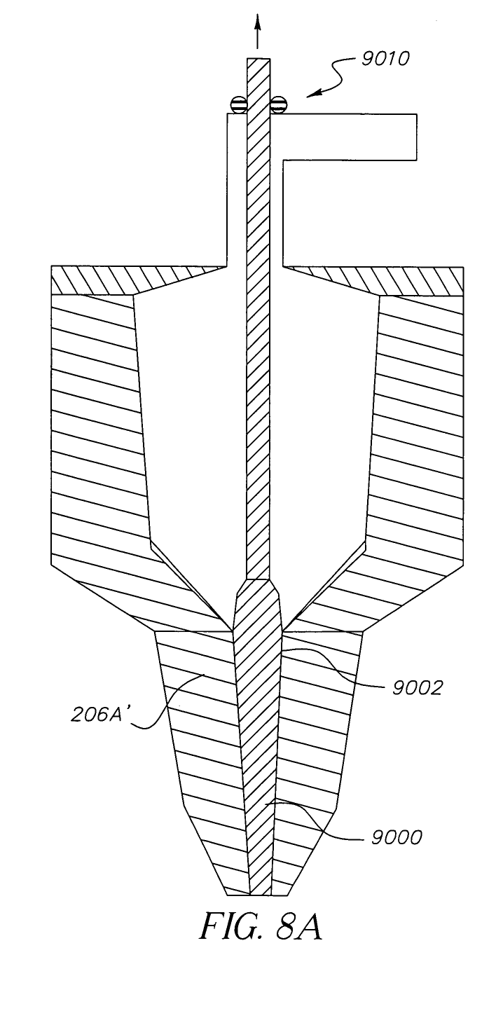

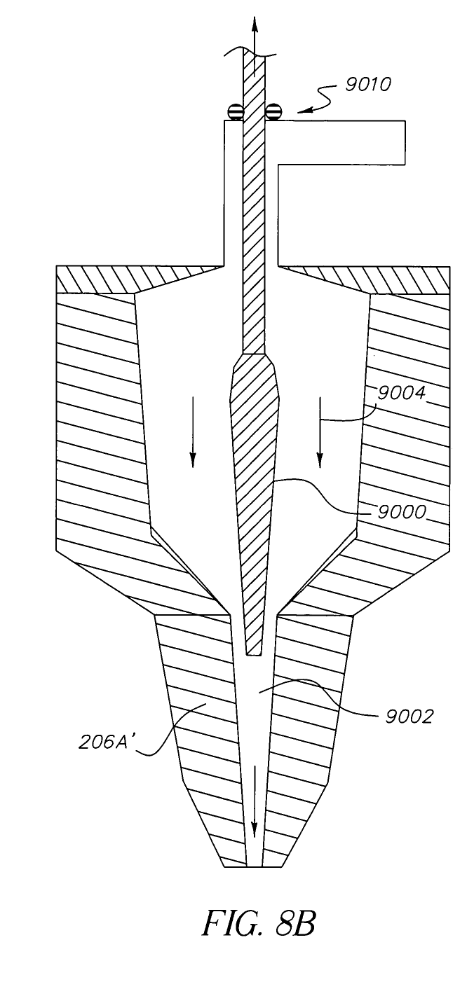

A further system and method for capping or sealing the applicator nozzle is shown in FIGS. 8A and 8B. In this further system, a mating blade 9000 (FIG. 8A) is pushed or inserted into a slot 9002 of nozzle 206A′ when the nozzle is not in service. The nozzle slot 9002 and blade 9000 have a slight taper to guide the blade 9000 and improve sealing. The blade arrangement as shown in FIGS. 8A and 8B does not require a web or web path and it provides an active mechanism for forcing dried contamination and clogs out of the nozzle 206A′.

FIG. 8B shows blade 9000 in the process of being inserted into slot 9002 in direction 9004. Once inserted, blade 9000 will seal the nozzle 206A′ and slot 9002 as shown in FIG. 8A. To further enhance sealing, an O-ring seal can be located at the entrance to slot 9002. To move blade 9000, any device for achieving a linear movement as shown can be used.

Therefore, the present invention provides for a maintenance device or cartridge 264 that has incorporated therein a cleaning device, system or station 1008 and a capping device, system or station 1000b, which are incorporated within an enclosure of the maintenance device 264. Maintenance device 264 cooperates with pivotal applicator nozzle 206A such that applicator nozzle 206A can be moved from an operating position where the applicator nozzle 206A applies fluid onto photographic media, to a cleaning position where nozzle 206A can be repeatedly wiped by a cleaning web, and then to a capping or sealing position where nozzle 206A can be sealed. The movement, pivoting or rotation of the nozzle can be achieved by any well-known movement, pivoting or rotating means.

The present invention therefore provides for a maintenance method for an applicator nozzle 206A which includes moving a face of nozzle 206A into contact with web 1002 of cleaning device 1000a, with the web extending between supply reel 1008 and take-up reel 1006; and advancing the web 1002 while the face of the applicator nozzle 2006A is in contact with the web 1002 to constantly introduce a clean portion of the web 1002 on the face of the applicator nozzle 206A and clean the face of the applicator nozzle.

In a feature of the present invention, the face of the applicator nozzle can be moved-back and forth into contact with the web so as to assure a complete cleaning of the web. In essence, after a first cleaning cycle, the applicator nozzle 206A can be moved away from the web and thrust back into contact with the web to repeat the cleaning cycle and assure a cleaning of the nozzle. After cleaning, the applicator nozzle 206A can be placed back into an operating position or in a preferred embodiment, the applicator nozzle 206A can be moved to a capping position or device 1000b, where the nozzle 206A is moved into contact with a capping web 5000 of capping device 1000b. In the capping or sealing method, the face of the nozzle 206A can be moved into contact with the web 5000 for the purpose of providing a sealing layer from the capping web on the face of the applicator nozzle 206A.

Accordingly, in a preferred development method in accordance with the present invention, the nozzle is utilized in an operating mode to apply processing solution onto photographic media. After a processing cycle, for example, the application of photographic solution onto a single order of film or the application of photographic solution onto multiple film orders, the face of the applicator nozzle can be moved from the operating position to a cleaning position where the face of the applicator nozzle is in contact with a cleaning web. At that point, the cleaning web can be advanced while the face of the applicator nozzle is moved into further contact with the web to constantly clean the face of the applicator nozzle. After this cleaning process, the applicator nozzle can be moved to a sealing location to seal the face of the applicator nozzle with a sealing layer.

The invention has been described in detail with particular reference to certain preferred embodiments thereof, but it will be understood that variations and modifications can be effected within the spirit and scope of the invention.

1. A maintenance method for an applicator nozzle of a development cartridge adapted to apply processing fluid onto photographic media, the method comprising the steps of:
moving a face of an applicator nozzle of a development cartridge into contact with a web of a cleaning device, said web extending between a supply roller and a take-up roller; and
advancing the web while the face of the applicator nozzle is in contact with the web to constantly introduce a clean portion of the web on the face of the applicator nozzle and clean the face of the applicator nozzle.

2. A method according to claim 1, comprising the further step of: moving the face of the applicator nozzle away from said web and to an operating position where said applicator nozzle is adapted to apply processing fluid onto a surface of photographic media.

3. A method according to claim 1, comprising the further steps of: moving the face of the applicator nozzle away from said web;
moving the face of the applicator nozzle back into contact with said web; and
advancing the web in a direction from the supply roller to the take-up roller to continue cleaning the face of the applicator nozzle.

4. A method according to claim 1, comprising the further steps of:
moving the cleaned applicator nozzle into contact with a capping web of a capping device, said capping web comprising a guiding layer and a sealing layer; and
sealing the face of said applicator nozzle with the sealing layer on said web.

5. A method according to claim 3, comprising the further step of:
moving the face of the applicator nozzle away from said web and to an operating position where said applicator nozzle is adapted to apply processing fluid onto a surface of photographic media.

6. A method of cleaning an applicator nozzle of a development cartridge, the method comprising the steps of:
moving an applicator nozzle of a development cartridge into contact with a web; and
advancing the web while the applicator nozzle is in contact with the web to constantly introduce a clean portion of the web on the applicator nozzle and clean the applicator nozzle.

7. A maintenance device for an applicator nozzle of a development cartridge, the maintenance device comprising:
a cleaning web supply reel operationally associated with a spring member that is adapted to apply a resistance torque on the supply reel;
a cleaning web take-up reel operationally associated with a one-way clutch; and
a cleaning web adapted to travel from the cleaning web supply reel to the cleaning web take-up reel, such that during a cleaning cycle an applicator nozzle to be cleaned is brought into contact with said cleaning web while the cleaning web is advanced in a direction from said cleaning web supply reel to said cleaning web take-up reel;
wherein:
during said cleaning cycle said one-way clutch permits a rotation of the cleaning web take-up reel in a winding direction to wind the cleaning web which is soiled as a result of contact with said applicator nozzle on said cleaning web take-up reel, and prevents a rotation of the cleaning web take-up reel having the soiled cleaning web thereon in an unwinding direction; and
said spring member and one-way clutch keeps at least a span of the cleaning web which contacts the face of said applicator nozzle at a minimum tension during said cleaning cycle.

8. A maintenance device according to claim 7, further comprising a capping device, said capping device including a capping web supply reel, a capping web take-up reel and a capping web adapted to travel from said capping web supply reel to said capping web take-up reel, such that after said cleaning cycle, said applicator nozzle is adapted to contact said capping web to permit a sealing layer on said capping web to seal the face of the applicator nozzle.

9. A method of processing photographic media, the method comprising the steps of:
placing an applicator nozzle of a development cartridge in an operating position and applying processing fluid from the applicator nozzle onto an exposed photographic media to initiate development of images on the exposed photographic media;
moving a face of the applicator nozzle from said operating position to a cleaning position where the face of said applicator nozzle is into contact with a web of a cleaning device; and
advancing the web while the face of the applicator nozzle is in contact with the web to constantly introduce a clean portion of the web on the face of the applicator nozzle and clean the face of the applicator nozzle.

10. A method according to claim 9, comprising the further step of moving the cleaned applicator nozzle to a sealing location to seal the face of the applicator nozzle with a sealing layer.

11. A method of processing photographic media, the method comprising the steps of:
placing an applicator nozzle of a development cartridge in an operating position and applying processing fluid from the applicator nozzle onto an exposed photographic media to initiate development of images on the exposed photographic media, wherein a processing cycle is defined by at least one application of processing fluid from said applicator nozzle to said photographic media;
scanning the photographic media as the images are developed to create a digital representation of the images;
at the end of said processing cycle, moving a face of the applicator nozzle from said operating position to a cleaning position where the face of said applicator nozzle is into contact with a cleaning web of a cleaning device, said web being adapted to travel from a supply member to a take-up member; and
advancing the web in a direction from the supply member to the take-up member while the face of the applicator nozzle is in contact with the web to constantly introduce a clean portion of the web on the face of the applicator nozzle and clean the face of the applicator nozzle.

12. A method according to claim 1 1, comprising the further step of:
resuming said processing cycle by moving said applicator nozzle from said cleaning position to said operating position.

13. A method according to claim 11, comprising the further step of:
moving said cleaned applicator nozzle from said cleaning position to a sealing position where a sealing layer is placed on the face of the applicator nozzle.

14. A method according to claim 13, comprising the further step of:
moving said cleaned and sealed applicator nozzle to said operating position.

15. A maintenance device for an applicator nozzle of a development cartridge, the maintenance device comprising:
a cleaning mechanism comprising a cleaning web which is adapted to clean a face of an applicator nozzle of a development cartridge when the face of the applicator nozzle is brought into contact with said web; and
a capping mechanism comprising a capping web adapted to seal the face of the applicator nozzle when the applicator nozzle is brought into contact with said capping web.

16. A device according to claim 15, wherein said cleaning web and said capping web are located within an enclosure.

17. A device according to claim 15, wherein said cleaning mechanism comprises a cleaning web take-up reel and a cleaning web supply reel, such that the cleaning web is advanced in a direction from the cleaning web supply web to the cleaning web take-up reel when the face of the applicator nozzle is in contact with said cleaning web.

18. A device according to claim 15, wherein said capping mechanism comprises a capping web supply reel and a capping web take-up reel.

19. A device according to claim 15, further comprising a backup pad mounted on an articulated rocker located behind a portion of the capping web which opposes the face of the applicator nozzle.

20. A device according to claim 15, wherein said capping web comprises a carrier layer which is adapted to advance and guide the capping web and a sealing layer which is conformable to the face of the applicator nozzle.

21. A maintenance device for an applicator nozzle of a development cartridge, the maintenance device comprising:
a cleaning mechanism adapted to clean a face of an applicator nozzle of a development cartridge; and
a capping mechanism adapted to seal the face of the applicator nozzle.

22. A device according to claim 21, wherein said capping mechanism comprises a chamber adapted to receive a tip of the applicator nozzle therein, said chamber comprising a fluid reservoir adapted to maintain air within said chamber saturated.

23. A device according to claim 21, wherein said capping mechanism comprises a blade adapted to be inserted into a slot of said applicator nozzle.
